(19) United States
(12) Patent Application Publication
(10) Pub. No.: US 2013/0052509 A1
(43) Pub. Date: Feb. 28, 2013

(54) LITHIUM ION BATTERY WITH ELECTROLYTE-EMBEDDED SEPARATOR PARTICLES

(71) Applicants: Ion C. Halalay, Grosse Pointe Park, MI (US); Scott W. Jorgensen, Bloomfield Township, MI (US)

(72) Inventors: Ion C. Halalay, Grosse Pointe Park, MI (US); Scott W. Jorgensen, Bloomfield Township, MI (US)

(73) Assignee: GM GLOBAL TECHNOLOGY OPERATIONS LLC, Detroit, MI (US)

(21) Appl. No.: 13/217,455

(22) Filed: Aug. 25, 2011

(51) Int. Cl. H01M 2/16; H01M 10/04; H01M 2/18

(52) U.S. Cl. 429/129; 29/623.1; 29/623.5

(57) ABSTRACT

A lithium ion battery in which electrically-non conducting ceramic particles are interposed between the anode and cathode to enforce separation between them and prevent short circuits is described. The particles, preferably equiaxed or monodisperse, may be generally uniformly dispersed in a non-aqueous gelled or high viscosity electrolyte. The electrolyte may be applied to one or both of the anode and cathode in suitable thickness to deposit the particles with the electrolyte and form a layered composite with substantially uniformly spaced particles suitable for holding the opposing anode and cathode faces in spaced-apart relation. The thickness of the applied electrolyte layer will be selected to enable deposition of the particles substantially as a fractional monolayer, a monolayer, or a multilayer as required for the application.

### TECHNICAL FIELD

This invention pertains to methods of preventing internal short circuits between facing electrode layers of cells of a lithium-ion battery using ceramic particles in a non-aqueous ionic electrolyte.

### BACKGROUND OF THE INVENTION

Lithium-ion secondary batteries are common in portable consumer electronics because of their high energy-to-weight ratios, lack of memory effect, and slow self-discharge when not in use. Rechargeable lithium-ion batteries are also being designed and manufactured for use in automotive applications to provide energy for electric motors to drive vehicle wheels.

The basic unit of a lithium-ion battery is an individual cell which includes a facing anode and cathode in spaced-apart relation, and, between them, a non-aqueous liquid electrolyte suitable for carrying and conveying lithium ions. Lithium-ion batteries of different sizes, shapes and electrical capabilities may be fabricated by arranging any suitable number of these cells in parallel, series or a combination of these to develop a battery of suitable voltage and capacity. During battery discharge a typical lithium-ion battery operates by oxidizing elemental lithium, intercalated in a graphite-containing negative electrode material (anode), and transporting lithium ions through a suitable electrolyte from the negative electrode to a lithium-ion-receiving positive electrode material (cathode). Simultaneous with this flow of lithium ions is a flow of electrons from the negative electrode through an external circuit and power-consuming device(s) to the positive electrode to power the external device. During battery charge the flow of lithium ions are reversed by an imposed electrical potential, returning lithium ions to the anode where they are reduced to elemental lithium and, ideally, re-intercalated in the carbon constituent of the electrode material. In practice, however, less than 100% lithium re-intercalation occurs, leading to a progressive build-up of lithium and lithium containing reaction compounds on the anode surface during continued cycling. Under some conditions, such surface lithium deposits may lead to the formation of dendrites or protrusions which extend out from the surface of the anode toward the cathode.

To prevent physical contact (electron-conducting contact) between the anode and cathode which would result in an internal short circuit, a separator is commonly interposed between the positive and negative electrodes during cell assembly. The separator is often a polyolefin sheet or membrane which contains microscopic pores which extend from one surface to the other. These pores, which are necessary to provide a continuous electrolyte path for reversible transport of lithium ions during charging and discharging, require subjecting the polymer sheet to specialized processes and procedures, complicating the fabrication of such lithium-ion cells and posing a barrier to the movement of the lithium ions which reduces the maximum current that may be achieved.

Such polymer sheets, particularly at battery operating temperatures of greater than room temperature, or, about 25° C., have limited resistance to physical penetration. Such penetration may result from the above-mentioned accumulation of lithium protrusions on the anode surface or from metallic fines produced during battery manufacture and incorporated into the battery. When these conductive materials penetrate the polymer separator sheet and bridge the anode-cathode gap, a short circuit results. The high current, high temperature short circuit results in further damage to the separator, eventually enabling portions of the anode and cathode to come into face-to-face contact, resulting in extensive short circuiting and rapid battery failure.

There is thus a need for a simpler, more durable means of minimizing internal short circuits in lithium ion cells.

### SUMMARY OF THE INVENTION

Lithium ion batteries generally comprise a cell stack consisting of a plurality of anodes and cathodes arranged face-to-face and in mutual contact with an electrolyte, but held apart and out of electrical contact with one another by a separator placed between them. In practice of this invention these electrodes are held apart by a plurality of particles with a characteristic dimension of between 2 and 30 micrometers interposed between and contacting the anode and cathode faces. The separation between anode and cathode is substantially determined by the characteristic dimension of the particles but may be affected by the surface roughness of the electrode faces. It is preferred to use as low a concentration of particles as possible so that the particles do not inhibit access of the ions to the electrodes, a phenomenon known as ‘shadowing’. A monolayer or less of particle coverage may be adequate to assure separation if the stiffness of the electrode and its foil current collector support is adequate to prevent deflection of the electrode in regions not directly supported by the particles.

Commonly the anode is a thin carbonaceous layer deposited on a copper foil current collector and the cathode is lithium-based active material laid down on an aluminum current collector. Suitable cathode materials, among many others, include, a layered or spinel lithium transition metal oxide or a transition metal phosphate material that can undergo lithium intercalation and de-intercalation. A single anode-separator-cathode grouping may be only 100 micrometers thick and, because of this small thickness, a cell stack may be fabricated by rolling the electrodes in a spiral. Both cylindrical and prismatic cells may be fabricated in this manner. Layered cell construction may also be employed using stacked individual electrode sheets or employing a W-fold or Z-fold construction in which one electrode is interleaved in the folds of the other. During all of these fabrication processes modest pressure, generally of less than about 1 atmosphere or about 15 pounds per square inch (psi) or so, may be applied to the electrodes and only the presence of the separator placed between the facing electrode surfaces prevents electrode-to-electrode contact and the resulting short circuit.

It is an object of this invention to maintain the spaced-apart configuration of the electrodes in a lithium-ion cell by positioning a plurality of electrically non-conducting particles between the facing surfaces of the anode and cathode. The particles function as mechanical supports, or as load bearing spacers, and serve to hold the facing electrode surfaces a pre-determined distance apart.

It is preferred that the particles be substantially uniformly distributed, as at least a fraction of a monolayer, to create a series of generally uniformly-dimensioned unsupported spans between the particles. In some applications, monolayer loadings or even multiple overlapping particle layers may be preferred. The particle concentration may be predetermined to ensure that the unsupported spans between particles do not sag under either manufacturing or in-service loads to an extent which would result in face-to-face electrode contact and extensive short-circuiting.

The particles may be substantially spherical or equiaxed powder particles, or of generally cylindrical form, for example chopped fibers, or even linear, moderately branched structures. Each particle may be characterized by a characteristic dimension: the particle diameter for a sphere; the smallest average dimension for an equiaxed particle; the diameter for a cylinder; and the shortest separation between sides of a concave envelope around a branched structure. The magnitude of the characteristic dimension, ranging from 2 to 30 micrometers will largely dictate the anode-cathode separation.

The particle size should be selected to accommodate the roughness of the electrode surfaces. In particular the particle size should be at least greater than the sum of the maximum profile heights, that is, the maximum peak to valley height, for both electrodes to ensure that the electrodes do not make contact.

Particles may be oxides, such as TiO₂, Al₂O₃, SiO₂, MgO and CaO, or nitrides such as cubic boron nitride or carbides such as silicon carbide or mixtures of such particles. It is preferred to maintain the substantially planar electrode faces a common distance apart over the entire facing area of the electrodes so the particles should be of substantially similar size. Monodisperse spherical particles, for example, SiO₂, TiO₂, ZrO₂ and Ta₂O₅ prepared by controlled hydrolysis of metal alkoxide in a dilute alcohol solution, which will establish a common anode to cathode distance, irrespective of their orientation on the surface, may be preferred. These particles typically range from about 0.5 to 1.0 micrometer in diameter but some particles of up to 6 micrometers in diameter have been prepared. Preferably these particles are non-contacting and spaced apart to better accommodate the non-aqueous electrolyte and to minimize electrode shadowing for good conductivity between the electrodes but contacting or even overlapping particle arrays may be used.

To further enhance ionic conductivity the particles may be porous. Approaches to forming particles with suitably large pores may be to use colloidal templating or to partially sinter the monodisperse particles described previously so that necks form between adjacent particles but much of the porosity is retained. The partially-sintered compact may then be crushed and sized. The through-particle porosity may enable additional conduction paths for the ions and enhance conductivity so that a higher volume fraction of separator particles may be tolerated in the electrolyte without detriment to the current-delivering capabilities of the battery. This may be significant for particle configurations with multiple, overlying layers of particles.

Lithium-ion batteries commonly employ low-viscosity non-aqueous electrolytes which include one or more lithium salts which may include LiPF₆, LiClO₄, LiAlCl₄, LiI, LiBr, LiSCN and LiBF₄ dissolved in one or more organic solvents including carbonates, esters, lactones and ethers, among others.

However, any electrically insulating particles substantial enough to support the loads applied to the electrodes will move rapidly through the electrolyte under the influence of gravity. So application of particles dispersed in a conventional electrolyte may be expected to produce a non-uniform particle distribution and leave at least some portion of the electrolyte deficient in particles. Any region of the electrode in contact with a particle-deficient region of the electrolyte will be more readily able to move into contact with the facing electrode when under mechanical load and initiate a short circuit.

This may be avoided by uniformly dispersing the particles in a much more viscous non-aqueous electrolyte, for example a gelled electrolyte. The viscosity of the gelled electrolyte is selected to prevent settling of the particles, but capable of being readily applied, in a layer of controlled thickness to one or other of the battery electrodes while maintaining suitable ionic conductivity. An electrolyte with a viscosity of about 100 centipoise (cP) suitably satisfies this requirement but electrolytes with viscosities as low as 30 cP may also be used. A gel may be laid down on a smooth surface as a layer of generally uniform thickness, using for example a doctor blade or comma coater or similar device. A gel with a uniform distribution of particles of diameter smaller than the layer thickness will promote a generally uniform particle spacing in the layer. The electrodes however will have a roughened surface, so that there will be some tendency for the particles to segregate to the valleys or low spots on the surface and a more non-uniform particle distribution may result.

It is preferred that the thickness of the particle-containing gel layer be substantially equal to the intended thickness of the particle layer. If a single layer or a fraction of a single layer of particles is desired, then the gel layer thickness should be substantially equal to the particle size. If multiple layers of particles are desired, the gel layer thickness should be adjusted accordingly. Preferably only minimal electrolyte run-out will occur, but any run-out may be made up after battery assembly, and the particle placement on the electrode will not be substantially disturbed during any run-out. Similarly, any squeeze-out of electrolyte which may occur when the facing electrode is placed atop the first electrode and its particle-containing electrolyte layer will not substantially disturb the particle distribution.

Such an electrolyte gel may be prepared by addition of electrically non-conducting thickeners with sufficient electrochemical stability such as PVdF (Polyvinylidene Fluoride) or gelling agents such as fumed silica, alumina or titania to conventional non-aqueous electrolyte-solvent compositions in any proportion. However the most desired level is the minimum amount that will suspend the particles without separation during storage, transport and application. This additive concentration may vary with the gelling agent and process conditions but may, in general, lie between about 1% and 50% by weight. If the gel will be made and applied immediately (without storage or transport) lower concentrations would be viable and desired. Other electrolyte compositions which are inherently gelled or gel-like may also be used. Examples include vitreous eutectic mixtures represented by the formula AxBy is where A is a salt chosen from a lithium fluorosulfonimide, either a lithium fluoroalkylsulfonimide or a lithium fluoroarylsulfonimide, and B is a solvent chosen from an alkylsulfonamide or an arylsulfonamide. Even in such gelled electrolytes further modification and adaptation of the electrolyte viscosity may be achieved by additions of thickeners and gelling agents. The gelled electrolytes should exhibit specific (ionic) conductivities of between 3 and 15 mS/cm at room temperature or about 25° C.

It may be preferred to coat or impregnate the electrodes with ungelled electrolyte prior to battery assembly, to ensure good ionic transport within the electrode and good electrolyte continuity between electrode and separation layer. For similar reasons, if porous particles are employed, they may be impregnated with un-gelled electrolyte prior to incorporation into the gel electrolyte to ensure that their pore spaces are filled with electrolyte and enhance their ionic conductivity.

These and other aspects of the invention are described below, while still others will be readily apparent to those skilled in the art based on the descriptions provided in this specification.

### BRIEF DESCRIPTION OF THE DRAWINGS

FIG. 1 shows, in cross-section, a fragmentary schematic view of an exemplary lithium ion cell illustrating a particle-dispersed separator layer where the particles are generally monodisperse spherical particles.

FIG. 2 shows, in cross-section, a fragmentary schematic view of an exemplary lithium ion cell illustrating a particle-dispersed separator layer where the particles are generally equiaxed uniformly-sized particles.

FIG. 3 shows, in cross-section, a fragmentary schematic view of an exemplary lithium ion cell illustrating a particle-dispersed separator layer where the particles are generally equiaxed uniformly-sized particles formed by partially sintering monodisperse spherical particles.

FIG. 4 shows, in fragmentary schematic cross-section the application of a uniformly-thick layer of gelled electrolyte containing a fractional monolayer of generally uniformly dispersed equiaxed particles to a smooth-surfaced anode from a lithium ion cell.

FIG. 5 shows, in fragmentary schematic cross-section the application of a uniformly-thick layer of gelled electrolyte containing two layers of generally uniformly dispersed equiaxed and spherical particles to a smooth-surfaced anode from a lithium ion cell.

FIG. 6 shows, in fragmentary schematic cross-section, a particle-containing gelled electrolyte laid down on a rough-surfaced anode from a lithium ion cell and containing a fraction of a monolayer of generally equiaxed particles.

FIG. 7 shows a perspective view of a representative particle distribution on the anode and current collector of FIG. 6.

### DESCRIPTION OF PREFERRED EMBODIMENTS

The following description of the embodiment(s) is merely exemplary in nature and is not intended to limit the invention, its application, or uses.

Conventional lithium-ion batteries employ a porous polymer interlayer or separator located between the anode and cathode of the cell to enforce separation of the electrodes and protect against internal short-circuits. Such separators, particularly at elevated temperatures may have limited resistance to penetration by electrically-conductive entities. Such entities may include fines or debris from battery manufacture, or lithium dendrites, lithium protrusions which form on the anode over some number of battery charge-discharge cycles and extend into the separator. If these electrically-conductive entities can span the full extent of the gap between electrodes a local short circuit will occur as these entities carry a very large current density and melt or vaporize to break the electrical connection and end the short circuit.

These local short circuit events may not in themselves promote catastrophic battery failure. However, sometimes the resulting dramatic local increase in temperature promotes further separator damage at the short circuit site and precipitates an increasingly severe and extensive short event which will lead to battery failure and eventual thermal runaway.

It is an object of this invention to replace the porous polymer separator with a fraction of a monolayer or a multilayer array of electrically non-conducting ceramic particles which serve as spacers to enforce electrode separation. Each ceramic spacer particle may be in contact its neighbors but it is preferred that the spacers be distanced from one another, preferably by a more or less constant distance. The maximum allowable interparticle separation distance may be calculated based on the stiffness of the electrode and its permitted maximum deflection under load. Over spans of up to about 50 micrometers, typical electrodes are sufficiently stiff that they will exhibit only limited deflections of less than about 1 micrometers under typical pressures of up to 15 psi associated with battery operation.

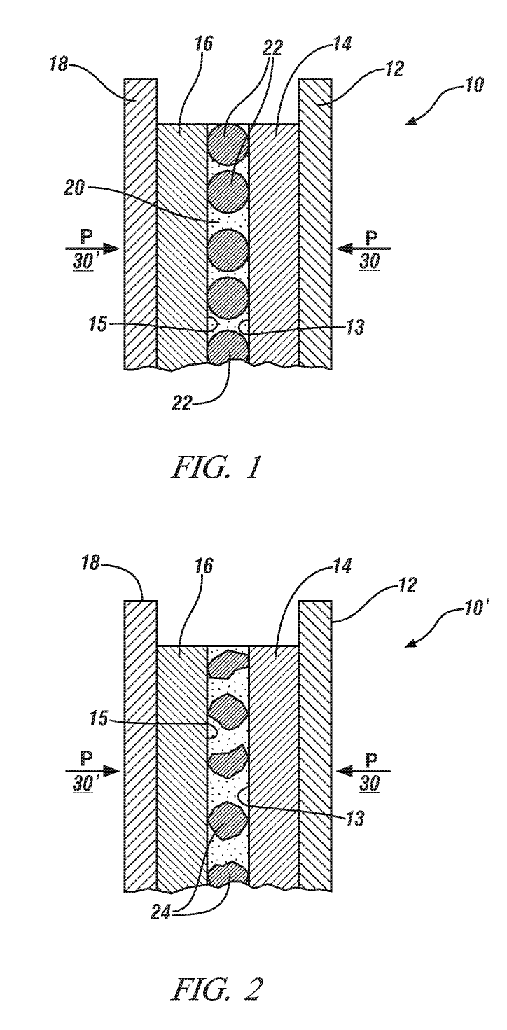

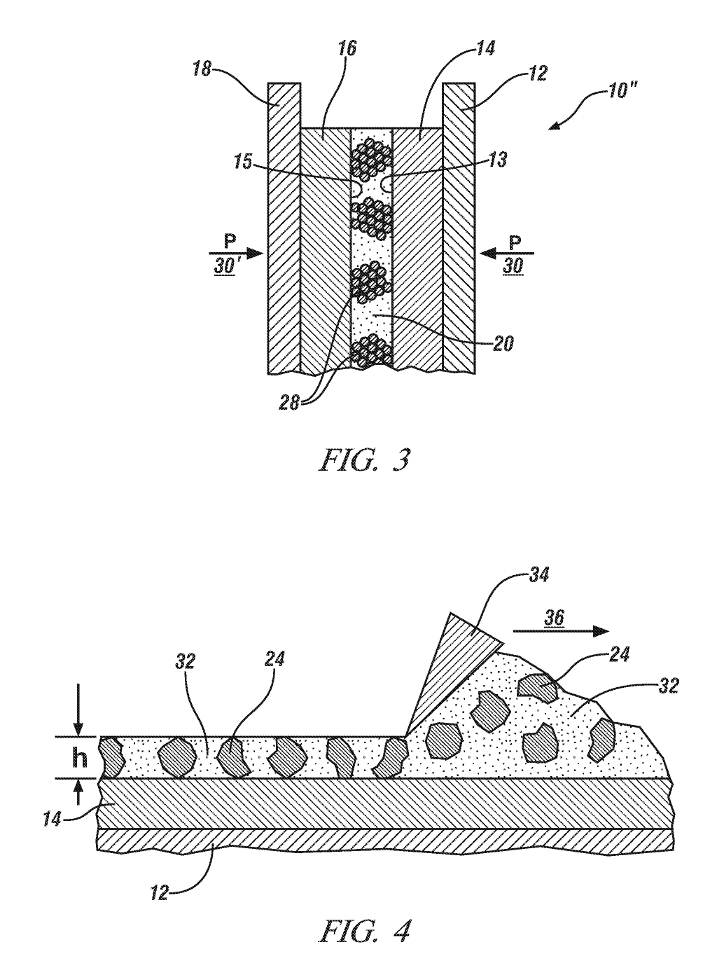

The general arrangement of the battery electrodes and ceramic spacer particles for fragmentary cells 10, 10′ and 10″ is shown in FIGS. 1, 2 and 3. Elements common to all three figures include: anode 14 and its associated current collector 12; cathode 16 and its current collector 18; and electrolyte 20. Facing anode surface 13 is maintained spaced-apart from cathode surface 15 by particles, shown as: spherical or quasi-spherical particles 22 in cell 10 (FIG. 1); angular, generally equiaxed particles 24 in cell 10′ (FIG. 2) and porous particles 26 formed of partially-sintered smaller particles 28 in cell 10″ (FIG. 3). Facing electrode surfaces 13 and 15 are held in contact with each of particles 22, 24 and 26 by a pressure P applied in opposing directions as shown by arrows 30 and 30′ and within each particle set 22, 24 and 26, the particles are substantially equally spaced and similarly sized. The size similarity of the particles will ensure that no particle is excessively loaded by application of pressure P and that the facing surfaces 15 and 13 are maintained approximately parallel to one another.

The internal resistance of the battery is reduced and battery performance is enhanced if the anode and cathode are separated by only a small distance. It is therefore preferred that each of particles 22, 24 and 26 be suitably sized to ensure that electrode faces 13 and 15 are maintained apart but in close proximity. Because of the pressure P of up to 15 psi applied during battery assembly, the particle density must be chosen to ensure that any deflection of the electrodes resulting from pressure P is insufficient to bring electrode faces 13 and 15 into contact. Deflection of the relatively stiff electrodes over a span of the order of 50 micrometers or so is expected to be only about 1 micrometer and it is preferred to maintain the designed spacing between electrodes at all times. Typically this value is between 1 micrometer and 10 micrometers. With the anticipated loading and resultant electrode deflection due to packaging and making allowance for surface roughness as well as the possibility of partial particle embedment in the electrodes, a particle size of between about 2 and 12 micrometers is preferred although particle sizes up to 30 micrometers may be used. For spherical or equiaxed particles the particle size will equal the particle diameter or largest dimension. For chopped fiber, cylindrical particles the particle dimension is the diameter of the cylinder and for branched particles the shortest separation between sides of a concave envelope around the branched structure. At a span of 50 micrometers the interparticle spacing for spherical or equiaxed particles, under uniform particle distribution, would be about four particle diameters, leading to a particle area fraction of about 8% and a volume fraction of less than 5%. The area fraction is important because the electrode area in the shadow of the particle will receive and accept fewer lithium ions than unshadowed areas and so make a lesser contribution to the current delivered by the battery. For maximum battery performance a low particle area fraction is preferred.

The cited low particle area fraction, however is based on a uniform particle loading. This is unlikely. The interaction between the particles and the roughened surface of the electrode will tend to promote particle segregation and non-uniform particle loading. The likelihood of electrode to electrode contact depends on the maximum span anywhere on the electrode faces, so any segregation in any location on the electrode will result in a dilution of particle density elsewhere, leading to a greater particle to particle spacing and a longer electrode span. To counter this dilution, particles may be added in excess so that even with some segregation at least a minimum particle spacing is maintained everywhere on the electrode. A particle volume fraction of up to about 20% would correspond to an area fraction of about 30% and would not excessively compromise battery performance. The size of the particles may be selected to ensure a preferred minimum stand-off distance between the facing electrode surfaces. But the greater the electrode separation the greater the internal resistance of the battery. Hence once electrode separation may be assured, taking into account manufacturing variation, further spacing-apart the electrodes confers no benefit and will degrade battery performance, so minimum electrode spacing is preferred.

Lithium ion cell electrodes will have some surface roughness and the different nature of each of the electrode materials means that each electrode may be characterized by a separate roughness. To ensure that the electrode surfaces, no matter how they are positioned will always be held apart by the ceramic particles the particles should be sized so that their diameter, for spherical particles is at least as large as the sum of the peak-to-valley dimensions of each of the facing electrode surfaces. Also, at least a portion of a particle may embed itself in the electrode surface. This is desirable for retaining the particles in place but is another factor to consider in selecting an appropriate particle size which satisfies the goal of consistently maintaining only a small inter-electrode separation throughout the life of the battery without risking electrode to electrode contact.

Suitable, electrically-insulating ceramic particles may include oxides, nitrides or carbides. Exemplary, but non-limiting compositions, include TiO₂, Al₂O₃, SiO₂, MgO and CaO, cubic boron nitride and silicon carbide or mixtures of such particles. It is preferred that the particles have a narrow size distribution and that, for ease of application, they be spherical or equi-axed although generally cylindrical chopped fiber particles or mildly branched particles or particle chains may also be satisfactory. Monodisperse particles may be suitable. Monodisperse quasi-spherical oxide powders of, for example, SiO₂, TiO₂, ZrO₂ and Ta₂O₅, have been prepared, for example, by controlled hydrolysis of metal alkoxide in a dilute alcohol solution, but many monodisperse particles have dimensions of about a micrometer or less, potentially too small to accommodate even the smoothest electrodes with roughnesses of between 1 and 2 micrometers Ra. However, some monodisperse silica particles have been prepared with diameters of up to 6 micrometers and these may be suitable.

Alternatively, suitably sized particles may be prepared by crushing of bulk materials followed by sizing. For larger particles sizing may be by screens while for finer particles sedimentation or flotation techniques may be employed. Shadowing may be minimized by using porous particles which admit electrolyte in the pores and allow passage of some ions through the pores to permit greater ionic access to the electrode. Microporous particles such as zeolites may be suitable provided the pore size is suitable for accommodating the diffusion of the ions under the electric field across the electrolyte solution. Alternatively, macroporous particles formed by colloidal templating or porous particles formed by partial sintering of fine particles sufficient to form interconnecting necks between abutting followed by crushing and sizing may be used, as depicted at FIG. 3.

The conventional non-aqueous electrolytes used in current-practice lithium-ion batteries have relatively low viscosity and are charged to the pre-assembled battery, with its pre-placed porous polymer separator, as flowable liquids. A similar approach, particle pre-placement, might be followed when using particles as separators since the particles, once positioned, will be held in place by at least friction, or by partially embedding themselves into one, other or both electrode surfaces under the assembly pressure. But the particle placement challenge is significant: the particles should be generally distributed over the entire electrode surface; inter-particle spacings should be less than about 50 micrometers; and the particles may be distributed as a fraction of a monolayer or as several overlying layers depending on the size of the particles relative to the desired electrode spacing and desired inter-particle spacing. Other factors such as likelihood of dendrite formation, foreign material incorporation, or abuse tolerance may also suggest value in closer particle spacing or multiple layers of particles.

It is challenging to satisfy these requirements by application of dry powder to an electrode. But, these requirements may be satisfied by forming a uniform distribution of particles in a viscous or gelled electrolyte and laying down a controlled thickness layer of the electrolyte. Application of such a thin controlled layer of electrolyte, and its associated particles, is readily accomplished using a doctor blade, slot die coater, comma coater or similar technique. The thickness of the electrolyte should be about equal to, but greater than the maximum particle coating thickness and in no case less than the maximum particle size to avoid trapping particles in the spreader.

The electrolyte should have a viscosity of about 100 cP to minimize flow under gravity during battery assembly, but with appropriate practice electrolytes with viscosities as low as 30 cP may be used. Some runoff and squeeze-out of the electrolyte will occur as the opposing electrode is brought in to contact with the spacer particles but only minimal displacement of particles and changes in relative particle positioning should occur. Runoff and squeeze-out of the electrolyte may be accommodated by charging additional electrolyte after battery assembly and if necessary, an excess concentration of particles in the electrolyte may employed to achieve the desired particle distribution after battery assembly.

A monolayer or fraction of a monolayer distribution, if deposited on a smooth surface may result in a generally uniform dispersion of particles as shown in fragmentary view in FIG. 4. Doctor blade 34, on moving in direction of arrow 36 into a generally uniform dispersion of substantially equiaxed particles24 and gelled electrolyte 32 lays down a uniform layer, of thickness ‘h’ of gelled electrolyte 32 with substantially uniformly-spaced particles 24. The gel layer is shown applied to anode 14 applied to current collector 12 but application to cathode 16 (FIGS. 1-3) is similarly appropriate.

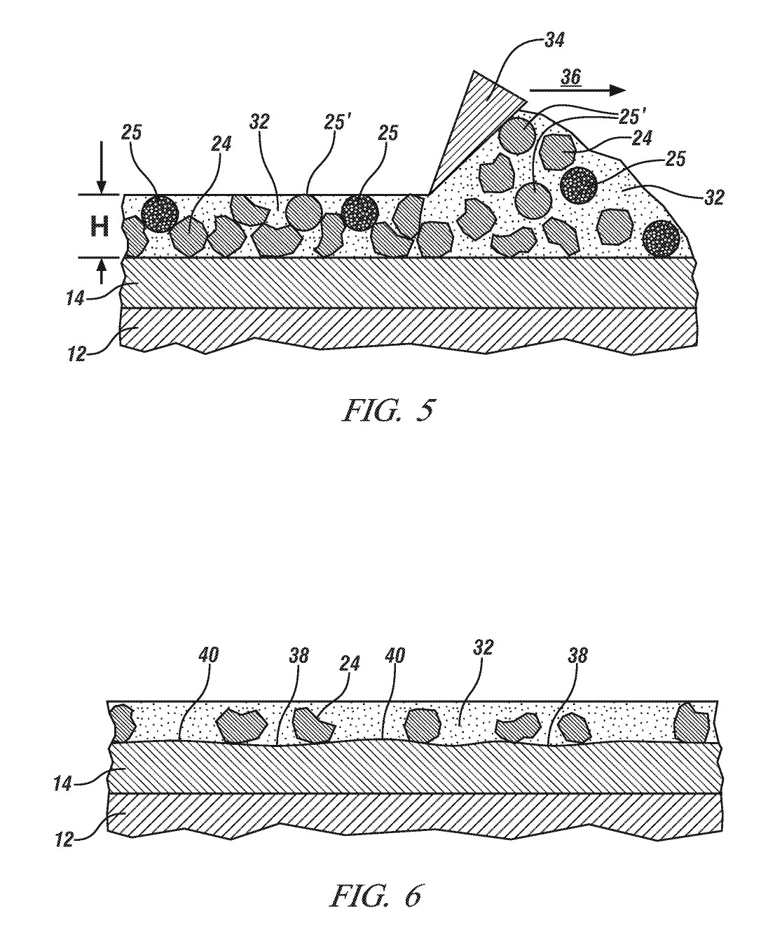

A multilayer particle coating may be applied in a similar manner as shown in FIG. 5, by adjusting the height of doctor blade 34 above anode 14 to ‘H’ and increasing the particle concentration. This example also serves to illustrate the scope of the invention and, in particular, that the invention is not restricted to particles of a particular shape or composition, Some particles are shown as spherical, for example 25 versus the more irregular generally equiaxed particles 24 shown both in this figure and in FIG. 4. Also some particles are indicated, by the nature of the hatching, as being of one composition for example 24 and 25′, while others 25 are of a second composition.

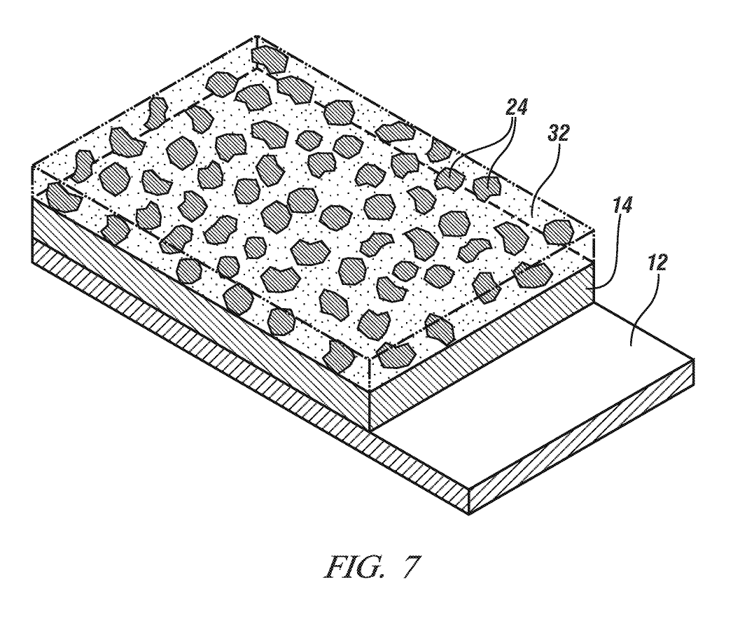

The above examples illustrate particle deposition on a substantially flat surface. However, on a rougher surface, such as is represented schematically in FIG. 6, electrolyte 32 has a flat surface but a variable depth, a greater depth at the low regions or valleys of the electrode surface, such as 38 and a lesser depth at peaks 40. Also the particles may tend to be preferentially deposited in the low regions or valleys 38 in the surface producing a non-uniform particle dispersion on the surface and creating some larger interparticle spacings. The larger the interparticle spacing the greater the electrode deflection under load. FIG. 7 shows, in perspective view a representative view of how particles 24 might be distributed on the surface of anode 14 when the particle density is suited for distributing the particles as a fraction of a monolayer.

In tightly-toleranced batteries the greater electrode deflection resulting from any larger interparticle spacing may result in electrode to electrode contact and internal short circuit. The effects of particle segregation may be offset by addition of excess particles. If less than monolayer coverage is desired, up to a particle excess of about 3 times or a particle volume fraction of about 20% may be accommodated without significant electrode shadowing or detriment to battery performance, but still greatly improved relative to current practice. With such a particle excess, the average thickness of the electrolyte layer may be increased by about the peak to valley height of the surface roughness so that the increased electrolyte depth will readily permit deposition of particles on peaks 40. Such an approach may however lead to additional squeeze-out and may, since it will promote larger electrode to electrode separation impact, battery performance

An alternative approach, requiring a reduced excess of particles, is to use particles with a wider size range to include more smaller-sized particles. Even without increasing the electrolyte depth, the larger particles would continue, as shown in FIG. 5, to segregate to the valleys 38 while the smaller particles could be deposited on the peaks 40.

Particularly, where less than monolayer particle coverage is employed, the sizing of the particles should take into account the extent to which the particles will be impressed into the electrode(s). Such impression is desirable in that it geometrically restrains the particles from migrating in use but undesirable because it reduces the interelectrode separation to less than the nominal particle dimension. Thus the particle size must be adjusted to ensure that even in the presence of expected surface roughness and taking into account impression of the particles in the electrode(s) any required minimum interelectrode spacing is maintained.

The overall performance of such a battery will depend on the electrode spacing and the resistance of the electrolyte, or, more properly since the electrolyte is a gel-particle composite, the area specific resistance of the composite. It is preferred that the gelled electrolyte itself have a conductivity of between 3 and 15 mS/cm at ambient temperature or about 25° C. or so. These electrolyte characteristics are compatible with a particle area fraction of up to about 30% and an electrode separation of up to 30 micrometers.

The practice of the invention has been illustrated through reference to certain preferred embodiments that are intended to be exemplary and not limiting. The full scope of the invention is to be defined and limited only by the following claims.

1. A lithium ion battery comprising an anode with a surface and a cathode with a surface, the anode surface and the cathode surface being maintained in spaced apart opposition only by a plurality of substantially uniformly dispersed, electrically non-conducting ceramic particles with characteristic dimensions of between 2 and 30 micrometers and disposed as at least a fraction of a monolayer between the anode and cathode surfaces; the particle characteristic dimension substantially enforcing the extent of the anode-cathode separation; and, the spaced apart anode and cathode surfaces confining between them a non-aqueous lithium-conducting electrolyte in ionic contact with the particles, the anode and the cathode.

2. The lithium ion battery recited in claim 1 in which the particles are of substantially equal characteristic dimension and are one or more of the group consisting of spherical, equiaxed, cylindrical and branched.

3. The lithium ion battery recited in claim 1 in which the particles are one or more of the group consisting of oxides, carbides and nitrides.

4. The lithium ion battery recited in claim 1 in which the particles are one or more oxides from the group consisting of TiO₂, Al₂O₃, SiO₂, MgO and CaO.

5. The lithium ion battery recited in claim 1 in which the electrolyte comprises a gelling agent in an amount sufficient to enable an electrolyte viscosity of between about 30 cP and 100 cP.

6. The lithium ion battery recited in claim 5 in which the electrolyte comprises a vitreous eutectic mixture.

7. The lithium ion battery recited in claim 6 in which the vitreous eutectic mixture is represented by the formula AxBy where A is a salt selected from a lithium fluorosulfonimide or a lithium fluorosulfonamide, and B is a solvent selected from an alkyl sulfonamide or an arylsulfonamide.

8. The lithium ion battery recited in claim 1 in which the specific conductivity of the electrolyte ranges from about 3 and 15 mS/cm at ambient temperature.

9. The lithium ion battery recited in claim 5 in which the specific conductivity of the electrolyte ranges from about 3 and 15 mS/cm at ambient temperature.

10. A method of fabricating a lithium ion battery comprising an anode with an anode surface and a cathode with a cathode surface, the anode surface and the cathode surface being held in spaced apart opposition only by a plurality of electrically non-conducting ceramic particles disposed as at least a fraction of a monolayer between the anode and cathode surfaces, the anode and cathode surfaces confining between them a non-aqueous, lithium-conducting electrolyte in ionic contact with the particles, the anode and the cathode, the method comprising:
substantially uniformly distributing a predetermined volume fraction of electrically non-conducting particles with characteristic dimensions of between 2 and 30 micrometers in an electrolyte with a viscosity ranging from 30 cP to 100 cP to form an electrolyte-particle mixture with a specific ionic conductivity of between 3 and 15 mS/cm;
applying a layer, of predetermined thickness, of the electrolyte-particle mixture to one or both of the anode and cathode surfaces; and
placing the anode surface in aligned opposition to the cathode surface and applying at least sufficient pressure to the anode and cathode to position the anode surface and the cathode surface in contact with the particles.

11. The method of fabricating a lithium-ion battery recited in claim 10 in which the particles are substantially uniformly dispersed.

12. The method of fabricating a lithium ion battery as recited in claim 10 in which the particles are substantially uniformly sized and are one or more of the group consisting of spherical, equiaxed, cylindrical and branched.

13. The method of fabricating a lithium-ion battery recited in claim 10 in which the particles are porous.

14. The method of fabricating a lithium-ion battery recited in claim 10 in which the predetermined thickness of the layer of the electrolyte-particle mixture is substantially equal to, but greater than the particle layer thickness.

15. The method of fabricating a lithium-ion battery recited in claim 10 in which the layer of the electrolyte-particle mixture is applied by one of a doctor blade, a slot die coater and a comma coater.

16. The method of fabricating a lithium-ion battery recited in claim 10 in which the particles are one or more of oxides, carbides or nitrides.

17. The method of fabricating a lithium-ion battery recited in claim 10 in which the particles are one or more oxides from the group consisting of TiO₂, Al₂O₃, SiO₂, MgO and CaO.

18. The method of fabricating a lithium-ion battery recited in claim 10 in which the electrolyte comprises a gelling agent.

19. The method of fabricating a lithium-ion battery recited in claim 10 in which the electrolyte comprises a vitreous eutectic mixture.

20. The method of fabricating a lithium-ion battery recited in claim 10 in which the vitreous eutectic mixture is represented by the formula AxBy where A is a salt selected from a lithium fluorosulfonimide or a lithium fluorosulfonamide, and B is a solvent selected from an alkyl sulfonamide or an arylsulfonamide.
